(19) United States
(12) Patent Application Publication
(10) Pub. No.: US 2021/0048695 A1
(43) Pub. Date: Feb. 18, 2021

(54) IMAGE SCANNING USING STATIONARY OPTICAL ELEMENTS

(71) Applicant: GM GLOBAL TECHNOLOGY OPERATIONS LLC, Detroit, MI (US)

(72) Inventors: Tzvi Philipp, Bet Shemesh (IL); Shahar Villeval, Tel Aviv (IL); Igal Bilik, Rehovot (IL)

(21) Appl. No.: 16/540,578

(22) Filed: Aug. 14, 2019

(51) Int. Cl. G02F 1/11; G02B 26/12; G02B 26/08; H04N 9/31; G02B 26/10

(52) U.S. Cl. CPC G02F 1/113; G02B 26/129; G02B 26/101; H04N 9/3129; G02B 26/0841

(57) ABSTRACT

A device for imaging a region of interest includes a scanning assembly configured to steer a light beam incident thereon relative to a target location. The scanning assembly includes a first stationary optical device configured to control a circular polarization direction of the light beam and transmit the light beam to a second stationary optical device, and the second stationary optical device is configured to deflect the light beam to the target location. The device also includes an image sensor configured to generate an image based on the deflected light beam.

### INTRODUCTION

The subject disclosure relates to the art of imaging and image detection and, more particularly, to a device, system and method for generating camera images via scanning.

Modern vehicles are increasingly equipped with cameras and/or other imaging devices and sensors to facilitate vehicle operation and increase safety. Cameras can be included in a vehicle for various purposes, such as increased visibility and driver awareness, assisting a driver and performing vehicle control functions. Conventional scanning systems use mechanical scanning devices, which can be complex and may have sub-optimal resolution. Accordingly, it is desirable to provide a system and device that includes stationary optical elements for image scanning.

### SUMMARY

In one exemplary embodiment, a device for imaging a region of interest includes a scanning assembly configured to steer a light beam incident thereon relative to a target location. The scanning assembly includes a first stationary optical device configured to control a circular polarization direction of the light beam and transmit the light beam to a second stationary optical device, and the second stationary optical device is configured to deflect the light beam to the target location. The device also includes an image sensor configured to generate an image based on the deflected light beam.

In addition to one or more of the features described herein, the first stationary optical device and the second stationary optical device include liquid crystal components.

In addition to one or more of the features described herein, the first stationary device is a liquid crystal half wave plate configured to control the circular polarization direction based on an applied voltage.

In addition to one or more of the features described herein, the second stationary device is a liquid crystal polarized grating configured to deflect the light beam by a selected angle in a deflection direction based on the circular polarization direction.

In addition to one or more of the features described herein, the device includes a quarter wave plate configured to transform the light beam between a linear circularization and a circular polarization.

In addition to one or more of the features described herein, the scanning assembly includes a plurality of pairs of optical devices in an optical path of the light beam, each pair of optical devices including a respective liquid crystal half wave plate and a respective liquid crystal polarized grating, each pair configured to deflect the light beam by a constituent angular direction.

In addition to one or more of the features described herein, the light beam is an illumination light beam emitted by a light source, the scanning assembly configured to direct the illumination beam to the target location by changing an angular direction of the illumination beam.

In addition to one or more of the features described herein, the light beam is a reflected light beam propagating along a direction from the target location to the scanning assembly, the scanning assembly configured to direct the reflected light beam to the image sensor by changing an angular direction of the reflected light beam.

In addition to one or more of the features described herein, the image sensor includes at least one of a complementary metal-oxide-semiconductor (CMOS) and a semiconductor charge-coupled device (CCD).

In one exemplary embodiment, a method of imaging a region of interest includes receiving a light beam from a light source at a scanning assembly, the scanning assembly including a first stationary optical device and a second stationary optical device, and steering the light beam relative to a target location by controlling the scanning assembly by a processing device. The steering includes controlling a circular polarization direction of the light beam by the first stationary optical device and transmitting the light beam to the second stationary optical device, deflecting the light beam by the second stationary optical device by a selected deflection angle, and generating an image of the target location by an image sensor based on the deflected light beam.

In addition to one or more of the features described herein, the first stationary device is a liquid crystal half wave plate configured to control the circular polarization direction based on an applied voltage, and the second stationary device is a liquid crystal polarized grating configured to deflect the light beam by a selected angle in a deflection direction based on the circular polarization direction.

In addition to one or more of the features described herein, the method further includes transforming the light beam between a linear circularization and a circular polarization by a quarter wave plate.

In addition to one or more of the features described herein, the scanning assembly includes a plurality of pairs of optical devices in an optical path of the light beam, each pair of optical devices including a respective liquid crystal half wave plate and a respective liquid crystal polarized grating, each pair configured to deflect the light beam by a constituent angular direction.

In addition to one or more of the features described herein, the light beam is an illumination light beam emitted by a light source, and the scanning assembly directs the illumination beam to the target location by changing an angular direction of the illumination beam.

In addition to one or more of the features described herein, the light beam is a reflected light beam propagating along a direction from the target location to the scanning assembly, and the scanning assembly directs the reflected light beam to the image sensor by changing an angular direction of the reflected light beam.

In one exemplary embodiment, a vehicle system includes a memory having computer readable instructions, and a processing device for executing the computer readable instructions. The computer readable instructions control the processing device to perform: receiving a light beam from a light source at a scanning assembly, the scanning assembly including a first stationary optical device and a second stationary optical device, and steering the light beam relative to a target location by controlling the scanning assembly by a processing device. The steering includes controlling a circular polarization direction of the light beam by the first stationary optical device and transmitting the light beam to the second stationary optical device, deflecting the light beam by the second stationary optical device by a selected deflection angle, and generating an image of the target location by an image sensor based on the deflected light beam.

In addition to one or more of the features described herein, the first stationary device is a liquid crystal half wave plate configured to control the circular polarization direction based on an applied voltage, and the second stationary device is a liquid crystal polarized grating configured to deflect the light beam by a selected angle in a deflection direction based on the circular polarization direction.

In addition to one or more of the features described herein, the processing device is further configured to perform: transforming the light beam between a linear circularization and a circular polarization by a quarter wave plate.

In addition to one or more of the features described herein, the light beam is an illumination light beam emitted by a light source, and the scanning assembly directs the illumination beam to the target location by changing an angular direction of the illumination beam.

In addition to one or more of the features described herein, the light beam is a reflected light beam propagating along a direction from the target location to the scanning assembly, and the scanning assembly directs the reflected light beam to the image sensor by changing an angular direction of the reflected light beam.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a top view of a motor vehicle including an imaging and scanning system, in accordance with an exemplary embodiment;

FIG. 2 depicts a computer system configured to perform imaging using a scanning assembly, in accordance with an exemplary embodiment;

FIG. 3 depicts an imaging device, in accordance with an exemplary embodiment;

FIG. 4 depicts the imaging device of FIG. 3 configured to steer an illumination beam to a target location;

FIG. 5 depicts the imaging device of FIG. 3 configured to steer a reflected beam from a target location to an imaging assembly;

FIG. 6 is a flow chart depicting a method of imaging a region of interest, in accordance with an exemplary embodiment;

FIG. 7 depicts components of a scanning assembly and illustrates beam steering by the scanning assembly, in accordance with an exemplary embodiment;

FIG. 8 depicts an imaging device including a transmission channel and a receiving channel, in accordance with an exemplary embodiment;

FIGS. 9A and 9B (collectively referred to as FIG. 9) depict components of a scanning assembly configured to steer light beams having different propagation directions; and

FIG. 10 depicts an imaging device including a plurality of image sensors in operable communication with a scanning assembly, in accordance with an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with one or more exemplary embodiments, methods and systems for image acquisition and imaging a region of interest are described herein. An embodiment of an imaging device or system includes a non-mechanical optical scanning assembly that is configured to shape and/or deflect incident light toward a direction corresponding to a selected target location, region of interest and/or portion of a region of interest. In one embodiment, the scanning assembly is configured to generate an image of a region of interest by scanning and imaging constituent portions of the region of interest. The scanning assembly may image portions based on discrete scan steps that each illuminate a subset of an angular field of view and/or receive reflected light from the subset.

The scanning assembly may be configured to image a region of interest using active illumination by scanning an illumination beam toward different target locations and steering reflected light from the target location to an image sensor or other sensor. The scanning assembly may be configured to use passive illumination including sunlight and/or other ambient light.

In one embodiment, the scanning assembly (whether utilizing active or passive illumination) includes liquid crystal optical elements or components that deflect an illumination beam and/or a reflected beam. For example, the scanning assembly includes a quarter wave plate to circularly polarize an illumination beam, a liquid crystal half wave plate to control the circular polarization direction (handedness) of the illumination beam, and a liquid crystal polarization grating configured to deflect the illumination beam according to a selected angle.

Embodiments described herein present a number of advantages. The imaging devices described herein provide an effective way to utilize non-mechanical scanning to acquire high resolution images. The imaging devices avoid the use of mechanical scanning devices (e.g., MEMS), which provides for a more robust construction that does not have moving parts for scanning, and thus is not as susceptible to wear and malfunction. In addition, the embodiments provide for a large field of view and the ability to scan in discrete steps, which allows for the utilization of potentially all sensor pixels.

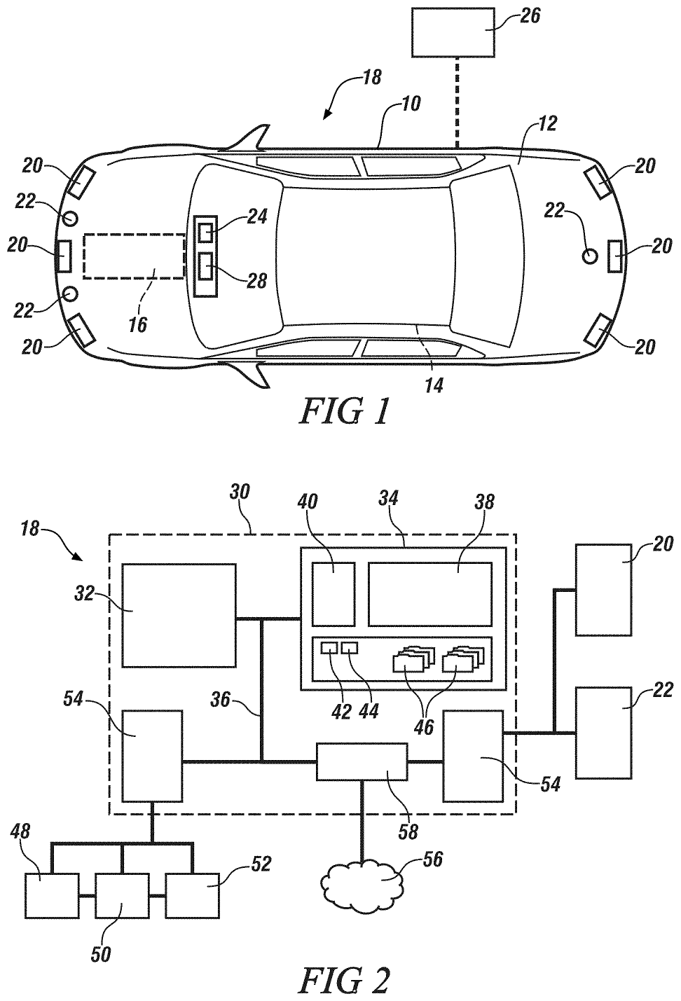

FIG. 1 shows an embodiment of a motor vehicle 10, which includes a vehicle body 12 defining, at least in part, an occupant compartment 14. The vehicle body 12 also supports various vehicle subsystems including an engine assembly 16, and other subsystems to support functions of the engine assembly and other vehicle components, such as a braking subsystem, a steering subsystem, a fuel injection subsystem, an exhaust subsystem and others.

One or more aspects of an imaging system 18 may be incorporated in or connected to the vehicle 10. The imaging system 18 in this embodiment includes one or more imaging devices 20 configured to scan a region of interest by taking multiple constituent images of various portions of the region of interest. The imaging devices 20 may utilize optical scanning in conjunction with an optical camera including an optical image sensor. The imaging devices 20 are not so limited, as they can utilize any suitable type of sensor. For example, the imaging devices 20 may utilize infrared sensors, time of flight sensors or other sensors that detect light or electromagnetic radiation. Additional devices or sensors may be included in the imaging system 18. For example, one or more radar or lidar assemblies 22 may be included in the vehicle 10.

The imaging devices 20 and/or radar assemblies 22 communicate with one or more processing devices, such as an on-board processing device 24, a remote processing device 26 and/or a processing device disposed within or connected to each imaging device 20. The vehicle 10 may also include a user interface system 28 for allowing a user (e.g., a driver or passenger) to input data, view images, and otherwise interact with a processing device and/or the imaging system 18.

The imaging system 18 can be incorporated into the vehicle 10 to perform a variety of functions. In one embodiment, the imaging system 18 can communicate with the vehicle 10 to facilitate full or partial autonomous control. For example, the imaging system 18 can be part of autonomous vehicle control and/or partial control such as steering assist and autonomous parking. The imaging devices 20 can be configured for use with, for example, side view mirrors, rear view cameras, blind spot identification and others.

FIG. 2 illustrates aspects of an embodiment of a computer system 30 that is in communication with, or is part of, the image analysis system 18, and that can perform various aspects of embodiments described herein. The computer system 30 includes at least one processing device 32, which generally includes one or more processors for performing aspects of image acquisition and analysis methods described herein. The processing device 32 can be integrated into the vehicle 10, for example, as the on-board processor 24, or can be a processing device separate from the vehicle 10, such as a server, a personal computer or a mobile device (e.g., a smartphone or tablet). For example, the processing device 32 can be part of, or in communication with, one or more engine control units (ECU), one or more vehicle control modules, a cloud computing device, a vehicle satellite communication system and/or others. The processing device 32 may be configured to perform imaging and scanning methods described herein, and may also perform functions related to control of various vehicle subsystems.

Components of the computer system 30 include the processing device 32 (such as one or more processors or processing units), a system memory 34, and a bus 36 that couples various system components including the system memory 34 to the processing device 32. The system memory 34 may include a variety of computer system readable media. Such media can be any available media that is accessible by the processing device 32, and includes both volatile and non-volatile media, removable and non-removable media.

For example, the system memory 34 includes a non-volatile memory 38 such as a hard drive, and may also include a volatile memory 40, such as random access memory (RAM) and/or cache memory. The computer system 30 can further include other removable/non-removable, volatile/non-volatile computer system storage media.

The system memory 34 can include at least one program product having a set (e.g., at least one) of program modules that are configured to carry out functions of the embodiments described herein. For example, the system memory 34 stores various program modules that generally carry out the functions and/or methodologies of embodiments described herein. A receiving module 42 may be included to perform functions related to acquiring and processing received images and information from sensors, and an analysis or processing module 44 may be included to perform functions related to imaging, scanning and image analysis. The system memory 34 may also store various data structures 46, such as data files or other structures that store data related to image detection and analysis. Examples of such data structures include camera images and radar images. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 32 can communicate with one or more devices such as the imaging devices 20 and the radar assemblies 22 for performing various imaging functions described herein. The processing device 32 can also communicate with one or more external devices 48 such as a keyboard, a pointing device, and/or any devices (e.g., network card, modem, etc.) that enable the processing device 32 to communicate with one or more other computing devices. The processing device 32 may also communicate with one or more networks 56 such as a local area network (LAN), a general wide area network (WAN), and/or a public network (e.g., the Internet) via a network adapter 58.

The processing device 32 can communicate with other devices that may be used in conjunction with the imaging system 18, such as a Global Positioning System (GPS) device 50 and vehicle control devices or systems 52 (e.g., for driver assist and/or autonomous vehicle control). Communication with various devices can occur via Input/Output (I/O) interfaces 54.

It should be understood that although not shown, other hardware and/or software components could be used in conjunction with the computer system 30. Examples include, but are not limited to: microcode, device drivers, redundant processing units, external disk drive arrays, RAID systems, and data archival storage systems, etc.

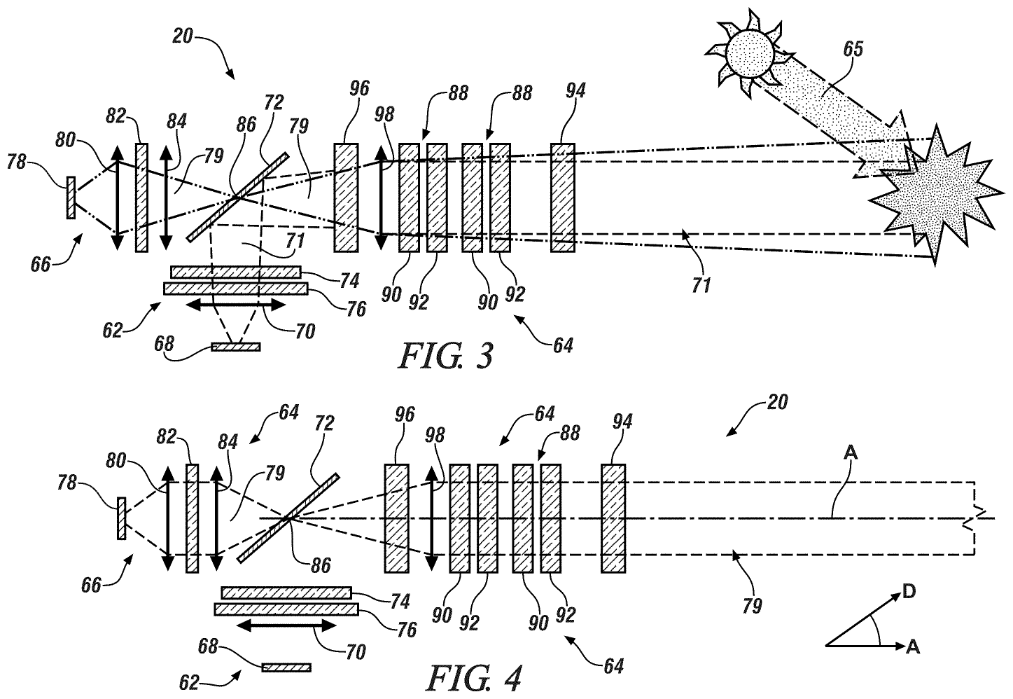

FIGS. 3-5 depict an embodiment of an imaging device 20 that includes at least an image sensing assembly 62 and a scanning assembly 64. The imaging device 20 may be configured to provide active illumination and/or utilize passive illumination (e.g., from ambient light and/or sunlight 65). In one embodiment, the imaging device 20 includes an active illumination assembly 66 that includes a light source that can be directed via the scanning assembly 64, as discussed further below.

Referring to FIG. 3, the image sensing assembly 62 includes an image sensor 68, which can be configured to detect visible light or other electromagnetic radiation. In one embodiment, the image sensor is a visible light image sensor, such as a complementary metal-oxide-semiconductor (CMOS) and/or semiconductor charge-coupled device (CCD). The image sensing assembly 62 is not so limited. For example, one or more other types of sensors, such as infrared, radar and/or time of flight sensors, may be incorporated into the image sensing assembly 62, either in place of or in addition to the image sensor 68.

In the embodiment of FIG. 3, the image sensing assembly 62 includes imaging optics and/or other components for directing light to the image sensor 68 and/or for directing light to selected portions (e.g., pixels) of the image sensor 68. For example, the sensing assembly 62 includes an imaging lens 70 to focus a reflected light beam 71 onto the image sensor 68. The image sensing assembly 62 may also include a beam splitter 72 and additional optics such as a polarizer 74 and a filter 76.

The illumination assembly 66 includes a light source 78 such as a diode laser, fiber laser or other light source. Examples of the light source 78 include a 904 nm diode laser and a 1550 nm fiber laser.

The illumination assembly 66 is configured to control an illumination beam 79, such as a coherent light beam emitted by a laser. For example, the illumination assembly 66 includes a collimating lens 80, a polarizer 82 and a focusing lens 84 that focuses the illumination beam 79 to an aperture 86 in the beam splitter 72. The beam splitter 72 has an aperture size located at or near the focus of the focusing lens 84, allowing the beam to be transmitted with high efficiency (e.g., greater than about 90%).

The scanning assembly 64 includes one or more stationary optical devices that are configured to steer or control the direction of light passing therethrough. The scanning assembly 64 utilizes the stationary optical devices to image one or more selected target locations or regions within a field of view (FOV).

To generate an image, the scanning assembly 64 directs incident light from a target region or location to the image sensing assembly 62. The target region is imaged by detecting reflected light incident on the scanning assembly 64 from a direction corresponding to an angle or angular interval (i.e., a range of angles between two angular values) relative to a central axis A, FIG. 4, of the scanning assembly 64. The scanning assembly 64 may be configured to scan discrete portions of the FOV by directing light from different target regions corresponding to subsets of the FOV.

Although the embodiment of FIG. 3 is shown as scanning along a two-dimensional FOV, it is not so limited and can be configured to scan within a three-dimensional FOV. For each target region, a reflected light beam including light having an angle within a corresponding angular interval is directed by the scanning assembly 64 to the image sensing assembly 62. As discussed further below, to image a FOV, the imaging device 20 scans multiple target regions and generates a constituent image of each target region, which can be combined to produce an overall image of the FOV. The scanning may be performed in discrete steps, referred to herein as scanning steps, where each scanning step results in an image of a target region within the FOV.

In one embodiment, the scanning assembly 64 includes one or more liquid crystal devices or optical components. For example, as shown in FIG. 3, the scanning assembly includes one or more pairs of directional liquid crystal control or steering optics (DLCCSO pair) 88. Each DLCCSO pair 88 includes a liquid crystal half-wave plate (LCHP) 90 configured to receive circularly polarized light and (when activated) change the direction of circular polarization. The direction of circular polarization, referred to as handedness, can be changed between left and right. The directions “left” and “right” are defined in terms of the direction of propagation of circularly polarized light. The handedness of incident light can be changed (i.e., from left to right or right to left), depending on the desired deflection direction, by alternating a drive voltage on the LCHP 90.

The DLCCSO pair 88 also includes a liquid crystal polarized grating (LCPG) 92 that is configured to deflect the circularly polarized light by a selected angle in a direction based on the handedness. The LCPG 92 adds a phase shift to the light of 180 degrees and deflects incident light through an angle θ, FIG. 4, in either a positive or negative direction based upon the handedness of the incident circularly polarized light.

As shown in FIG. 3, the scanning assembly 64 includes two DLCCSO pairs 88. However, embodiments described herein are not so limited, as the scanning assembly 64 may include any number of pairs. For example, each pair may be configured to deflect light (either positively or negatively) by a discrete angle, so that light transmitted therethrough is deflected by a total angle equal to the sum of each respective angle.

Light is iteratively deflected by a constituent angle by each DLCCSO pair 88, so that the discrete angle (the total deflection angle or total angular range) by which light is deflected by the scanning assembly 64 represents a summation of the constituent deflection angles produced by each DLCCSO pair 88. The constituent deflection angle for a given DLCCSO pair 88 may be based on the following equation:

mλ/d=sin θᵣ−sin θᵢ,

where m is the deflection order (either + or −1), λ is the wavelength of a deflected light beam, and d is the grating spacing of the LCPG 92. θᵢ is the incident angle, i.e., the angle of a light beam incident on a DLCCSO pair 88 relative to normal. θᵣ is the constituent deflection angle of the deflected light beam exiting the DLCCSO pair 88 relative to normal.

The DLCCSO pairs 88 of the LCHP 90 and the LCPG 92 can be repeated as many times as needed to generate the total angular range FOV required. The total angular range may correspond to the FOV. In one embodiment, the number of pairs is based on the optical losses generated per pass through each DLCCSO pair 88.

In one embodiment, the scanning assembly 64 includes an optical component or components configured to transform incident light between a linear polarization and a circular polarization. For example, the scanning assembly 64 includes at least one permanent quarter wave plate (QWP) 94 in an optical path of incident light to transform an incident light beam from linear to circular polarization to allow the DLCCSO pairs 88 to deflect the incident light beam according to a desired angle. Another QWP 96 may be positioned to transform light exiting the DLCCSO pairs 88 to linear polarization.

FIG. 4 depicts the imaging device 20 and operation thereof during a scanning operation, and specifically during an illumination phase of the operation in which an illumination beam 79 is scanned over a selected FOV. The selected FOV has an overall angular range. In this example, the angular range includes a plurality of angular steps or intervals that make up the total FOV. Each angular step is defined by an angle θ between central axis A of the imaging device 20 and an angular direction D.

For a given angular step θ, the illumination beam 79 is emitted by the light source 78, collimated by the lens 80 and filtered through the polarizer 82 to remove undesired polarizations. The illumination beam 79 is then focused by the focusing lens 84 to the aperture 86.

The illumination beam 79 then passes through the QWP 96 to transform the illumination beam 79 to a circular polarization. The QWP 96 introduces a phase change to the linear polarized light, thereby transforming it to circular polarized light. The circularly polarized beam is transmitted through a lens 98, which shapes the illumination beam 79 so that the beam has a divergence that corresponds to the selected angular step (or scan size).

The illumination beam 79 then passes through one or more DLCCSO pairs 88 of LCHPs 90 and LCPGs 92, which deflects the illumination beam 79 according to a selected angle. In one embodiment, each DLCCSO pair 88 deflects the illumination beam 79 by a constituent angle such that the illumination beam 79 is deflected by an angle corresponding to a specific angular step. The various states of the orders (positive or negative deflection) of the DLCCSO pairs 88 are alternated or otherwise controlled to generate combinations of scan angles that result in coverage over an entire desired FOV. For example, the DLCCSO pairs 88 may be controlled to result in a degenerate configuration, in which there is more than one combination of orders (if more than two DLCCSO pairs 88 are considered) to generate the desired coverage. For example, a subset of the DLCCSO pairs 88 (each of which have the same deflection angle or different deflection angles) are activated to produce a beam that is directed to a selected angular step.

In one embodiment, the deflected illumination beam 79 passes through another QWP 94 to return the polarization to linear polarization. The illumination beam 79 at this point is a combination of linear polarization states and ambient illumination. This linear polarization allows the scanning angles introduced in transmitted light to be canceled upon return. It is noted that in some embodiments, for example, in which active illumination is not employed, the QWP 94 may be omitted.

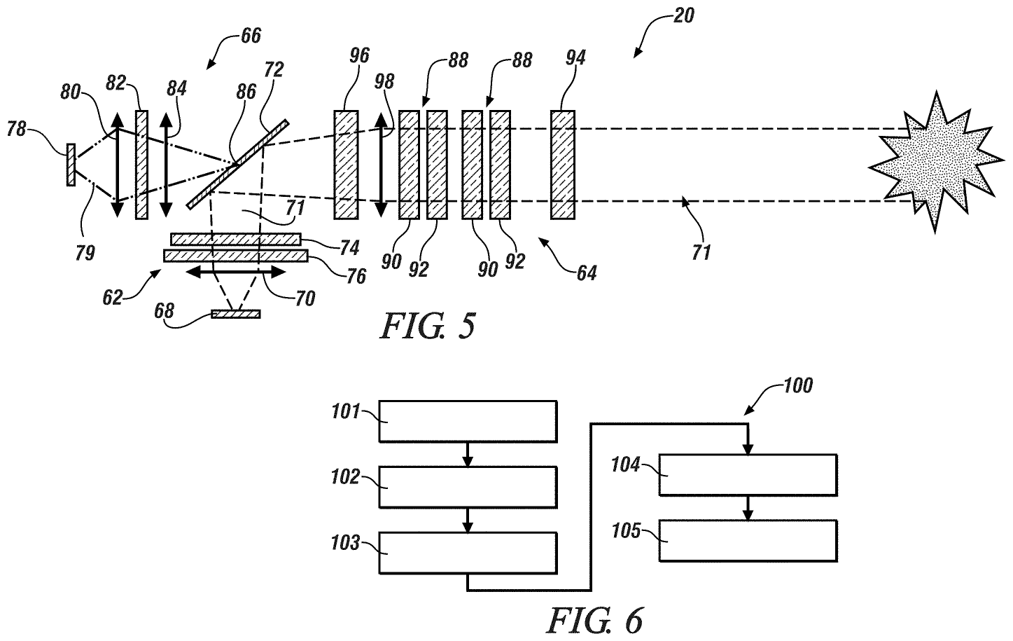

FIG. 5 depicts the imaging device 20 and operation thereof during the scanning operation, and specifically during an imaging phase of the operation in which a reflected beam 71 returns to the scanning assembly 64.

Upon being incident on a target region and retro reflecting, the reflected beam 71 is still linearly polarized, with a phase shift of 180 degrees due to the reflection. The reflected (and/or refracted) beam 71 enters the QWP 94, which transforms the reflected beam 71 back to circular polarization. The reflected beam 71 is then retraced through the scanning assembly 64 and the scanning angles originally introduced in the transmission are cancelled on the return path.

After exiting the scanning assembly 64, the reflected beam 71 impinges upon the beam splitter 72, which folds the reflected beam 71 relative to the illumination beam 79. The reflected beam 71 as directed by the beam splitter 72 passes through the polarizer 74 to maximize the reflected beam signal while reducing light from parasitic reflections. The reflected beam 71 also passes through the filter 76, which in this example is a solar filter to remove ambient background light.

The plane of the image sensor 68 is positioned in the conjugate plane of the scanned beam (e.g., the reflected beam 71). The image formed of the scanned region can be a high resolution image of the angular step and target region in a region of interest.

FIG. 6 depicts an embodiment of a method 100 of imaging a region of interest. The imaging device 20, or other suitable device or system, may be utilized for performing aspects of the method 100. All or part of the method may be controlled by a processing device connected to the imaging device 20. The method 100 is discussed in conjunction with blocks 101-105. The method 100 is not limited to the number or order of steps therein, as some steps represented by blocks 101-105 may be performed in a different order than that described below, or fewer than all of the steps may be performed.

At block 101, an illumination beam is emitted from a scanning assembly and steered using the scanning assembly so that the illumination beam has a direction and divergence that will cover a target region corresponding to a selected angular scan step. For example, the scanning assembly 64 is configured to scan a region of interest corresponding to a field of view in discrete scan steps of, for example, about 5 degrees. The divergence of the illumination beam is selected to cover a selected angular range for each step. For example, the beam divergence is selected to be about 5 degrees, so that at a scan step having a direction at 5 degrees will cover an angular range of about 2.5 degrees to about 7.5 degrees. The illumination beam may have a divergence that is larger than the difference between each scanning direction to allow for an overlap between images corresponding to adjacent scan steps.

At block 102, the illumination beam reflects from objects in a portion of the region of interest corresponding to the target region. Reflected light returns to the scanning assembly 64, where the reflected light coming from the target region is deflected through the scanning assembly 64 and is incident on an imaging assembly, such as the imaging assembly 62.

At block 103, the reflected light is directed to an image sensor such as the image sensor 68, which may be a CCD or CMOS sensor. The image sensor 68 detects the reflected light and forms an image of the corresponding target region.

At block 104, the illumination beam is steered by the scanning assembly 64 to another target region corresponding to another scan step, and another image of another target region is generated by the image sensor. Additional constituent images are generated as desired according to a number of scan steps until the entirety of a region of interest is imaged.

At block 105, the images generated via each scan step are combined to generate an overall image of the region of interest. In one embodiment, each image overlaps with an adjacent image and the processing device uses the overlap to ensure continuity of the overall image.

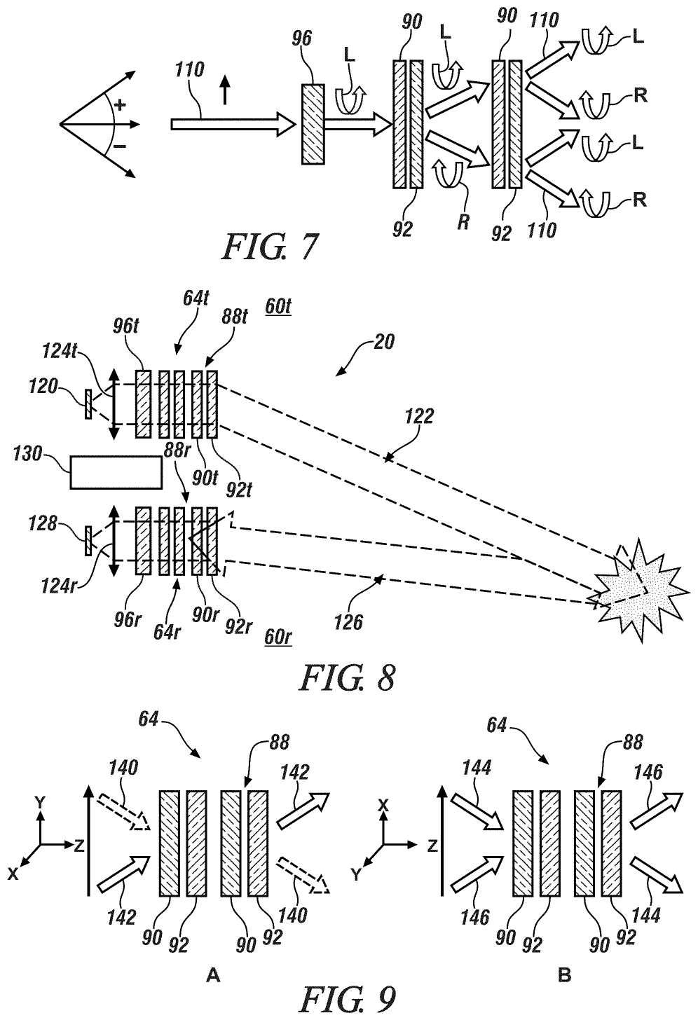

FIG. 7 depicts components of the scanning assembly 64 and illustrates how light (e.g., an illumination beam or a reflected beam) is deflected. A light beam 110 impinges on a QWP 96 and is transformed to a left handed circular polarization L. The circularly polarized beam 110 then impinges on an LCHP 90. A controller or processing device applies a voltage to cause the light beam 110 to retain the left handed polarization or transform the polarization to right handed polarization R.

Depending on the polarization direction (handedness), a LCPG 92 deflects the light beam 110 according to a pre-configured angle. For example, the light beam 110 is deflected according to a positive angle based on the circular polarization being left handed or to negative angle based on the circular polarization being right handed. In this example, the scanning assembly 64 includes a second pair of a LCHP 90 and a LCPG 92, which further deflects the light beam 110 according to another pre-configured angle. In this way, multiple pairs of steering optics can be provided to cause deflection according to a total desired angle.

As noted above, the scanning assembly 64 may include QWPs at both ends of the scanning assembly, but is not so limited. FIG. 8 shows an example of the imaging device 20, which includes a transmitting channel 60t and a receiving channel 60r. The transmitting channel 60t includes a light source 120 that emits an illumination beam 122. The illumination beam 122 impinges on a lens 124t to achieve a divergence of the beam 122 to be similar in size to a selected discrete beam scan size. This allows for uniform coverage over a desired region of interest or field of view.

The illumination beam 122 then passes through a scanning assembly 64t in the transmitting channel 60t, which includes a QWP 96t that circularly polarizes the beam 122. One or more DLCCSO pairs 88t of an LCHP 90t and a LCPG 92t deflect the illumination beam 122 by an angular step to image a target region of the region of interest or field of view.

Light from the target region is reflected back as a reflected beam 126, which is circularly polarized. The reflected beam 126 impinges on a scanning assembly 64r of the receiving channel 60r, and is deflected by a selected angle (which may be the same or different than the emitted angle). The deflected beam 126 passes through a QWP 96r that transforms the reflected beam 126 to linear polarization. A focusing lens 124r focuses the beam 126 onto an image sensor 128.

The transmitting channel 60t and the receiving channel 60r may be operated by a control unit 130 to operate the transmitting channel 60t and the receiving channel 60r in synchronized fashion, such that when the transmitting channel 60t is in a state to direct the projected beam 12 at a target through a selected angle θ, the receiving channel 60r is synchronized to be in a comparable state to allow visualization through an angle similar to the selected angle θ, to visualize the illuminated target region.

By appropriate calibration of the channels' co-fields of view, any observable offset of the field of view from the expected location of the field of view through the receiving channel 60r could be used to estimate the range to the targeted point in the region of interest.

In one embodiment, the imaging device is configured to direct and/or receive multiple incident light beams corresponding to different propagation directions. For example, as shown in FIG. 9, multiple illumination beams can be applied to the scanning assembly along various axes. FIG. 9A shows an example of two illumination beams 140 and 142 that are applied to the scanning assembly 64 from different angles in a vertical plane defined by an axis y, and are deflected to different portions of a region of interest or field of view. FIG. 9B shows an example of two illumination beams 144 and 146 applied to the scanning assembly 64 from different angles in a horizontal plane defined by an axis x, and deflected to different portions of a region of interest or field of view.

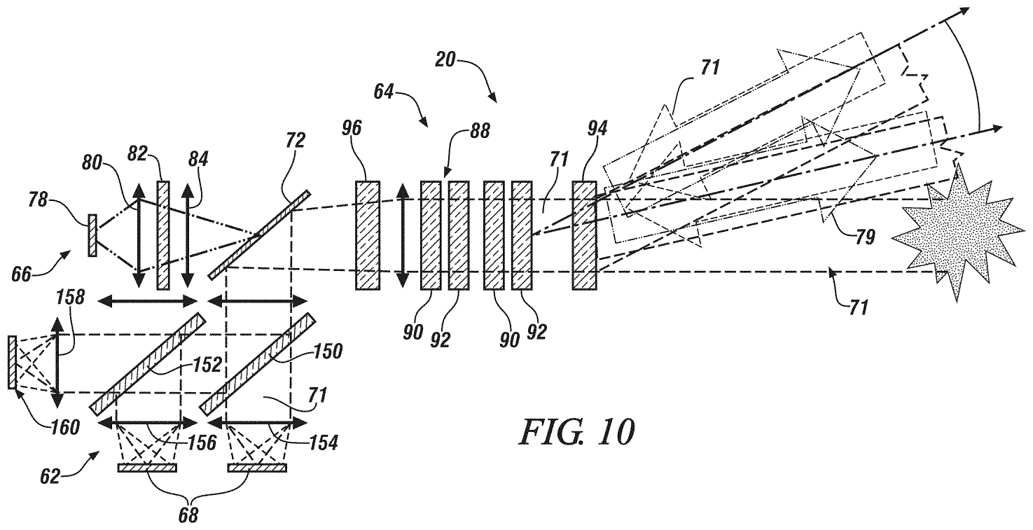

The imaging device 20 may be configured to image a region of interest using multiple image sensors and/or using multiple imaging modalities. FIG. 10 shows an embodiment of the imaging device 20 that is configured to simultaneously, or in parallel, image multiple scan steps and/or image the same scan step using multiple sensors. In this embodiment, the scanning assembly 64 steers an illumination beam 79 to multiple scan steps separated by an angular step denoted by angle θ. At each scan step, a reflected beam 71 is directed to one or more dichroic or proportionally based beam splitters that direct the reflected beam 71 to multiple sensors. Based on the target location, the scanning assembly 64 and the image sensing assembly 62 can direct light to different regions or pixels of an image sensor to utilize some or all of the available pixels when acquiring images.

For example, the sensors include first and second optical image sensors 68 and an infrared sensor 160. Reflected beams 71 are directed to the image sensing assembly 62 through a first beam splitter 150 that splits a reflected beam 71 and directs the split beam to one of the sensors 68. The reflected beam 71 is again split by another beam splitter 152 to direct the reflected beam 71 to another sensor 68 and the infrared sensor 160. The imaging device 20 in this embodiment allows for a near infrared depth image to be superimposed with a visible spectrum image.

Embodiments described herein present numerous advantages. For example, the imaging devices described herein are simpler and more cost effective than mechanical scanning devices such as MEMs devices. In addition, the imaging devices described herein can be manufactured more easily and with lower cost than mechanical scanning devices.

In addition, embodiments described herein allow for a relatively narrow field of view to be imaged per discrete scan position, which in turn allows for utilization of all of sensor pixels per discrete scan step to generate high resolution images for each step. In addition, the effective light collection of the systems and devices described herein can be large (e.g., from about one mm to about 50 mm), which is significantly larger than that of systems that utilize MEMs scanners. More light can thus be collected per scan step, which increases system sensitivity.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A device for imaging a region of interest, comprising:
a scanning assembly configured to steer a light beam incident thereon relative to a target location, the scanning assembly including a first stationary optical device configured to control a circular polarization direction of the light beam and transmit the light beam to a second stationary optical device, the second stationary optical device configured to deflect the light beam to the target location; and
an image sensor configured to generate an image based on the deflected light beam.

2. The device of claim 1, wherein the first stationary optical device and the second stationary optical device include liquid crystal components.

3. The device of claim 2, wherein the first stationary device is a liquid crystal half wave plate configured to control the circular polarization direction based on an applied voltage.

4. The device of claim 3, wherein the second stationary device is a liquid crystal polarized grating configured to deflect the light beam by a selected angle in a deflection direction based on the circular polarization direction.

5. The device of claim 4, further comprising a quarter wave plate configured to transform the light beam between a linear circularization and a circular polarization.

6. The device of claim 4, wherein the scanning assembly includes a plurality of pairs of optical devices in an optical path of the light beam, each pair of optical devices including a respective liquid crystal half wave plate and a respective liquid crystal polarized grating, each pair configured to deflect the light beam by a constituent angular direction.

7. The device of claim 1, wherein the light beam is an illumination light beam emitted by a light source, the scanning assembly configured to direct the illumination beam to the target location by changing an angular direction of the illumination beam.

8. The device of claim 1, wherein the light beam is a reflected light beam propagating along a direction from the target location to the scanning assembly, the scanning assembly configured to direct the reflected light beam to the image sensor by changing an angular direction of the reflected light beam.

9. The device of claim 1, wherein the image sensor includes at least one of a complementary metal-oxide-semiconductor (CMOS) and a semiconductor charge-coupled device (CCD).

10. A method of imaging a region of interest, comprising:
receiving a light beam from a light source at a scanning assembly, the scanning assembly including a first stationary optical device and a second stationary optical device; and
steering the light beam relative to a target location by controlling the scanning assembly by a processing device, wherein the steering includes:
controlling a circular polarization direction of the light beam by the first stationary optical device and transmitting the light beam to the second stationary optical device;
deflecting the light beam by the second stationary optical device by a selected deflection angle; and
generating an image of the target location by an image sensor based on the deflected light beam.

11. The method of claim 10, wherein the first stationary device is a liquid crystal half wave plate configured to control the circular polarization direction based on an applied voltage, and the second stationary device is a liquid crystal polarized grating configured to deflect the light beam by a selected angle in a deflection direction based on the circular polarization direction.

12. The method of claim 11, further comprising transforming the light beam between a linear circularization and a circular polarization by a quarter wave plate.

13. The method of claim 11, wherein the scanning assembly includes a plurality of pairs of optical devices in an optical path of the light beam, each pair of optical devices including a respective liquid crystal half wave plate and a respective liquid crystal polarized grating, each pair configured to deflect the light beam by a constituent angular direction.

14. The method of claim 10, wherein the light beam is an illumination light beam emitted by a light source, and the scanning assembly directs the illumination beam to the target location by changing an angular direction of the illumination beam.

15. The method of claim 10, wherein the light beam is a reflected light beam propagating along a direction from the target location to the scanning assembly, and the scanning assembly directs the reflected light beam to the image sensor by changing an angular direction of the reflected light beam.

16. A vehicle system comprising:
a memory having computer readable instructions; and
a processing device for executing the computer readable instructions, the computer readable instructions controlling the processing device to perform:
receiving a light beam from a light source at a scanning assembly, the scanning assembly including a first stationary optical device and a second stationary optical device;
steering the light beam relative to a target location by controlling the scanning assembly by a processing device, wherein the steering includes controlling a circular polarization direction of the light beam by the first stationary optical device and transmitting the light beam to the second stationary optical device, and deflecting the light beam by the second stationary optical device by a selected deflection angle; and
generating an image of the target location by an image sensor based on the deflected light beam.

17. The vehicle system of claim 16, wherein the first stationary device is a liquid crystal half wave plate configured to control the circular polarization direction based on an applied voltage, and the second stationary device is a liquid crystal polarized grating configured to deflect the light beam by a selected angle in a deflection direction based on the circular polarization direction.

18. The vehicle system of claim 17, wherein the processing device is further configured to perform: transforming the light beam between a linear circularization and a circular polarization by a quarter wave plate.

19. The vehicle system of claim 16, wherein the light beam is an illumination light beam emitted by a light source, and the scanning assembly directs the illumination beam to the target location by changing an angular direction of the illumination beam.

20. The vehicle system of claim 16, wherein the light beam is a reflected light beam propagating along a direction from the target location to the scanning assembly, and the scanning assembly directs the reflected light beam to the image sensor by changing an angular direction of the reflected light beam.
